(19) United States
(12) Patent Application Publication
(10) Pub. No.: US 2014/0348457 A1
(43) Pub. Date: Nov. 27, 2014

(54) BEARING MOUNTING COLLAR

(71) Applicant: Schaeffler Technologies GmbH & Co. KG, Herzogenaurach (DE)

(72) Inventor: Rocco Docimo, Stamford, CT (US)

(73) Assignee: SCHAEFFLER TECHNOLOGIES GMBH & CO. KG, Herzogenaurach (DE)

(21) Appl. No.: 14/275,222

(22) Filed: May 12, 2014

Related U.S. Application Data
(60) Provisional application No. 61/826,759, filed on May 23, 2013.

(51) Int. Cl. F16C 19/16

(52) U.S. Cl. CPC F16C 19/163
USPC 384/499

(57) ABSTRACT

A bearing sleeve assembly for a shaft system, having a bearing assembled between an inner and outer sleeve, the assembly mountable as a unitary sub-assembly or as separate components.

The present invention relates to bearings, in particular, mounting collars or sleeves for bearings.

### BACKGROUND

Bearings, specifically rolling element bearings are known for use in shaft support applications, for example for paper rolling mills. Depending on the location of the bearing relative to the loaded zone, the bearing may be required to support thrust or axial loads, radial loads or both. Often, loading may vary throughout the life of the bearing, requiring consideration of both thrust or axial loads and occasional radial loading patterns, or vice versa.

In addition, where bearings may need preventative maintenance or to be changed more frequently than the surrounding structures, namely the shaft and housing, it can be difficult and potentially damaging to the system components, to remove a bearing from a shaft and re-press a new bearing in position, causing excessive wear to the shaft and potential premature failure.

### SUMMARY OF THE INVENTION

Certain terminology is used in the following description for convenience and descriptive purposes only, and is not intended to be limiting to the scope of the claims. The terminology includes the words specifically noted, derivatives thereof and words of similar import.

The present invention relates to a bearing mounting collar assembly for a shaft system. The bearing sleeve assembly having a bearing assembled between an inner and outer sleeve, the assembly mountable as a unitary sub-assembly or as separate components.

### BRIEF DESCRIPTION OF DRAWINGS

The above mentioned and other features and advantages of the embodiments described herein, and the manner of attaining them, will become apparent and be better understood by reference to the following description of at least one example embodiment in conjunction with the accompanying drawings. A brief description of those drawings now follows.

FIG. 1 is a cross sectional view of a shaft mounted bearing assembly, including a mounting sleeve or collar, according to an example embodiment of the invention.

### DETAILED DESCRIPTION OF THE INVENTION

Identically labeled elements appearing in different ones of the FIGURES refer to the same elements but may not be referenced in the description for all FIGURES. The exemplification set out herein illustrates at least one embodiment, in at least one form, and such exemplification is not to be construed as limiting the scope of the claims in any manner.

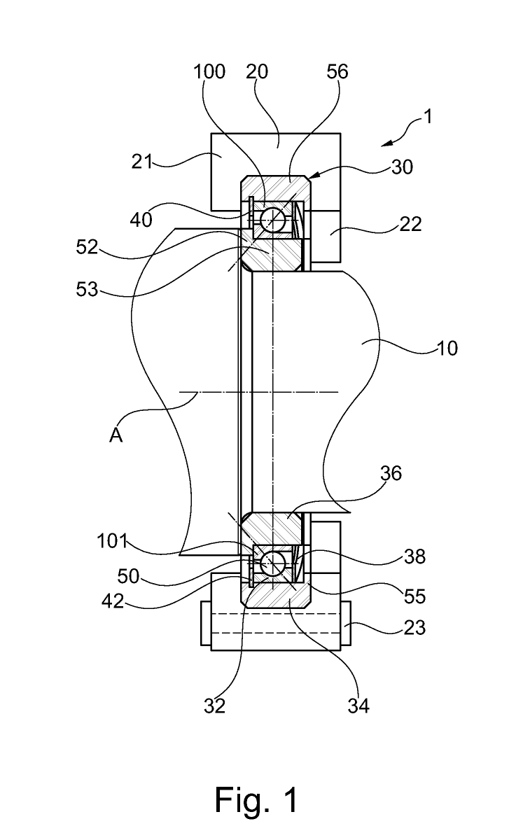

FIG. 1 is a cross sectional view of a shaft bearing assembly 1, comprising shaft 10, housing 20, and bearing sleeve assembly 30. The term axial refers to forces or directions along a longitudinal axis A of the assembly, and the terms radial refers to forces or directions orthogonal to longitudinal axis A. Housing 20 can be any housing known in the art, but, for illustrative purposes is shown as an externally supported, separatable collar-type housing, comprising collar segment 21, fixing means 23, such as bolts, and bushing shoulder ring 22. Bearing sleeve assembly 30 comprises rolling element bearing 32, outer sleeve 34, inner sleeve 36, optional snap ring 40 and optional preload spring 38. In the example embodiment shown, shaft 10 is rotating and housing 20 is fixed, although other arrangements are contemplated by the present invention and will be understood by those skilled in the art.

In the example embodiment, bearing sleeve assembly 30 can be pre-assembled separately from shaft bearing assembly 1, as a sub-assembly, and assembled onto shaft assembly 1 in a single operation. Alternatively, inner sleeve 36 can be pressed or otherwise fixedly mounted onto an outer radial surface of shaft 10, rolling element bearing 32 then fixedly mounted or pressed onto an outer radial surface of inner sleeve 36, then outer sleeve 34 pressed or otherwise mounted on an outer radial surface of bearing 32 Inner sleeve 36 may be axially extended to provide more contact area between sleeve 36 and shaft 10. In the embodiment shown, rolling element bearing 32 is an angular contact ball bearing, having a high contact angle, for example 40 degrees, though any rolling element bearing is contemplated by the present invention. Rolling element bearings are known in the art, and comprise inner and outer rings, with a plurality of rolling elements arranged between raceways on the outer radial surface of the inner ring and the inner radial surface of the outer ring, respectively. In an arrangement wherein axial loading is a greater factor than radial loading, optional preload spring 38 can be placed between outer ring 100, inner ring 101 and outer sleeve 34, and can be used in order to axially pre-load bearing 32, displacing ball 50 to or near its maximum contact angle, such that it is better situated to support thrust or axial loads. In an arrangement wherein radial loading is a greater factor than axial loading, preload spring 38 can be removed from the assembly. Similarly, snap ring 40 may be used to axially fix bearing 32 within bearing sleeve assembly 30. Snap ring 40 is placed within groove 42 of outer sleeve 34. In the embodiment shown, sleeves 34 and 36 are L-shaped, and mirror each other, such that a disc-shaped radial extension 52 of inner sleeve 36 extends radially outwardly from longitudinal cylindrical bearing support section 53, and is axially opposite to disc shaped radial extension 55 of outer sleeve 34 which extends radially inwardly from longitudinal cylindrical bearing support segment 56. In this manner, bearing 32 is confined in both axial directions. Once bearing sleeve assembly 30 is mounted on shaft 10, housing 20 is mounted on a radially outer surface of outer sleeve 34. In the embodiment shown, housing 20 has two separable halves or collars, that can be assembled over sleeve assembly 30, and supported in position using an external structure, such as a shaft parallel to shaft 10 (not shown).

In order to remove and replace bearing 32, housing 20 is removed from the assembly. Snap ring 40 and outer sleeve 34 are then removed. Bearing 32 is removed from sleeve 36 using any suitable press or other operation Inner sleeve 36 can remain on shaft 10, and a new bearing 32 pressed onto inner sleeve 36, re-assembling sleeve assembly 30, as described above. In this manner, no direct additional operations are performed on shaft 10.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the FIGURES illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying FIGURES.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

What we claim is:

1. A shaft and bearing assembly comprising;
a shaft;
a housing;
a bearing sleeve sub-assembly assembled on an outer radial surface of the shaft comprising;
a hollow cylindrical inner sleeve;
a hollow cylindrical outer sleeve;
a bearing assembled radially between the inner and outer sleeves,
the bearing comprising;
an inner ring having a raceway on an outer radial surface;
an outer ring having a raceway on an inner radial surface;
a plurality of rolling elements arranged between the raceways of the inner and outer rings;
the housing mounted on an outer radial surface of the bearing sleeve assembly;
the bearing sleeve assembly being separable, such that the hollow inner sleeve can remain mounted onto the shaft, and the bearing can be removed and replaced, and the sleeve assembly re-assembled onto the shaft.

2. The assembly of claim 1, wherein, the bearing is an angular contact ball bearing.

3. The assembly of claim 2, wherein, the bearing sleeve sub-assembly includes a pre-load spring between the bearing rings and the outer sleeve, to axially displace the rolling elements of the bearing.

4. The assembly of claim 1, wherein, the inner and outer sleeve are L-shaped, with the inner sleeve having a radially outwardly extending disc-shaped segment adjacent the bearing inner ring, and the outer sleeve having a radially inwardly extending disc-shaped segment adjacent the bearing outer ring, axially opposite the inner ring disc-shaped segment.

5. The assembly of claim 1, wherein, a snap ring is mounted in a groove in the outer sleeve, the snap ring axially retaining the bearing within the bearing sleeve assembly.

6. The assembly of claim 1, wherein, the housing comprises at least two separable semi-circular collar-type segments, joined by a fixing means.

7. A bearing sleeve assembly for a shaft assembly comprising:
a hollow cylindrical inner sleeve;
a hollow cylindrical outer sleeve;
a bearing assembled radially between the inner and outer sleeves,
the bearing comprising;
an inner ring having a raceway on an outer radial surface;
an outer ring having a raceway on an inner radial surface;
a plurality of rolling elements arranged between the raceways of the inner and outer rings;
the assembly mountable as a unitary sub-assembly or as separate components.

8. The assembly of claim 7, wherein, the bearing is an angular contact ball bearing.

9. The assembly of claim 8, wherein, the bearing sleeve assembly includes a pre-load spring between the bearing rings and the outer sleeve, to axially displace the rolling elements of the bearing.

10. The assembly of claim 7, wherein, the inner and outer sleeve are L-shaped, with the inner sleeve having a radially outwardly extending disc-shaped segment adjacent the bearing inner ring, and the outer sleeve having a radially inwardly extending disc-shaped segment adjacent the bearing outer ring, axially opposite the inner ring disc-shaped segment.

11. The assembly of claim 7, wherein, a snap ring is mounted in a groove in the outer sleeve, the snap ring axially retaining the bearing within the bearing sleeve assembly.
The hydraulic valve of claim 7, wherein, an additional axial retention means for the valve plate is a spring urging the valve plate against the valve housing shoulder.
